(19) United States
(12) Patent Application Publication
(10) Pub. No.: US 2004/0223000 A1
(43) Pub. Date: Nov. 11, 2004

(54) METHOD FOR ADJUSTING CHROMATIC IMAGE OF A DISPLAY APPARATUS

(76) Inventor: Chia-Hung Lin, Tai-Chung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,797

(22) Filed: Mar. 26, 2004

(30) Foreign Application Priority Data
Mar. 27, 2003 (TW) 092106999

(51) Int. Cl. G09G 5/02

(52) U.S. Cl. 345/604

(57) ABSTRACT

A method for adjusting chromatic images of a display apparatus includes (a) decoding video signals of a color bar pattern and converting them into RGB signals, (b) deleting two primary colors from the RGB signal, (c) displaying the remaining primary color on the display apparatus, and(d) adjusting the display apparatus according to the remaining primary color.

### BACKGROUND OF INVENTION

1. Field of the Invention

The present invention relates to a method of adjusting chromatic image of a display apparatus, and more specifically, to a method of adjusting chromatic image of a display apparatus by using a gamma gain circuit.

2. Description of the Prior Art

In the field of displays, devices such as televisions, screens, and projectors, are influenced by external factors. Problems with wires and transceivers occur in addition to TV stations, cable television providers, and various types of recorders compressing video signals. The color of the displayed image often does not match that of the original image. It is therefore beneficial for a display apparatus to provide chromatic adjusting capability for saturation and tint.

A conventional method of adjusting chromatic image is to input a color bar pattern by a peripheral to the display apparatus to be adjusted. For instance, when adjusting the screen of a computer, a color bar pattern is input by a hard disk drive or other peripherals such as a CD-ROM or a floppy disk drive. When adjusting the screen of a television, a color bar pattern is transmitted by a recorder or a TV station so that a user can adjust the screen by adjusting the color bar pattern with a monochromatic filter. However, the conventional method requires professional examiners and an additional monochromatic filter such as a filter lens or a filter film which is not readily available. Moreover, it is inconvenient that the conventional method requires a darkroom for adjusting images.

### SUMMARY OF INVENTION

It is therefore a primary objective of the present invention to provide a method for adjusting chromatic images of a display apparatus in order to solve the problems mentioned above.

Briefly summarized, a method for adjusting chromatic images of a display apparatus includes (a) decoding video signals of a color bar pattern and converting them into RGB signals, (b) deleting two primary colors from the RGB signal, (c) displaying the remaining primary color on the display apparatus, and(d) adjusting the display apparatus according to the remaining primary color.

According to the present invention, a display apparatus includes a gamma gain circuit for receiving RGB signals of a color bar pattern and controlling the deletion of two primary colors of the RGB signals, a display panel connected to the gamma gain circuit for displaying a remaining primary color after deleting the two primary colors of the RGB signals, and an adjusting device for adjusting video signals of the color bar pattern according to the remaining primary color in order to modify input video signal errors.

It is an advantage of the present invention that a primary color is output by the gamma gain circuit to have a filter generate a primary color in order to adjust chromatic images.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram illustrating a first display apparatus according to the first embodiment of the present invention.

FIG. 2 is a flow chart illustrating a method for adjusting chromatic images of the display apparatus shown in FIG. 1.

FIG. 3 is a diagram illustrating a color bar pattern.

FIG. 4 is a diagram illustrating a second display apparatus according to the second embodiment of the present invention.

FIG. 5 is a flow chart illustrating a method for adjusting chromatic images of the display apparatus shown in FIG. 4.

### DETAILED DESCRIPTION

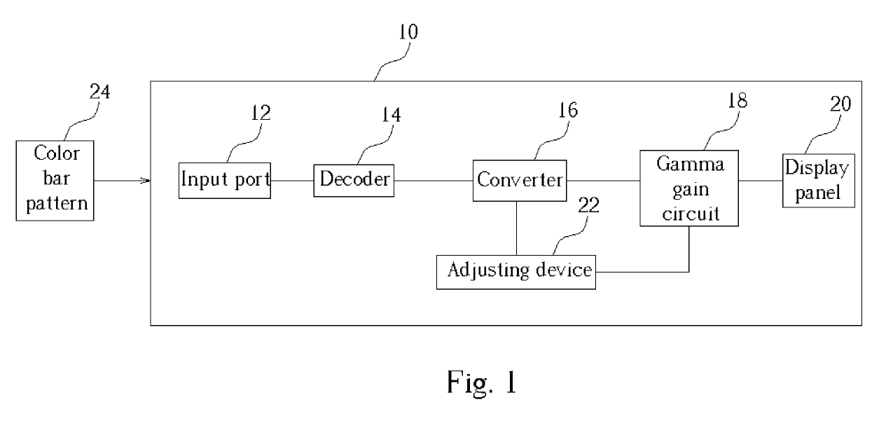

Please refer to FIG. 1. FIG. 1 is a block diagram illustrating a first display apparatus 10 according to the first embodiment of the present invention. The first display apparatus 10 includes an input port 12 capable of receiving signals from a variety of signal sources such as TV stations, cable TV providers, or various types of storing devices such as recorders, memories, or CD-ROMs. A decoder 14 is connected to the input port for decoding and generating a YUV signal, a converter 16 is connected to the decoder 14 for converting the YUV signal into an RGB signal, and a gamma gain circuit 18 including a program code is connected to the converter 16 for determining the gain of each color of the RGB signal converted by the converter 16, i.e. determining the output proportion of each color. A display panel 20 is used for displaying the RGB signals adjusted by the gamma gain circuit 18. The display panel 20 can be a liquid crystal display (LCD) panel, a cathoderay tube (CRT) screen, or a television screen. The first display apparatus 10 further includes an adjusting device 22 connected to the converter 16 and the gamma gain circuit 18 for adjusting the input proportion of the YUV signal and the gain of each color of the RGB signal output by the gamma gain circuit 18.

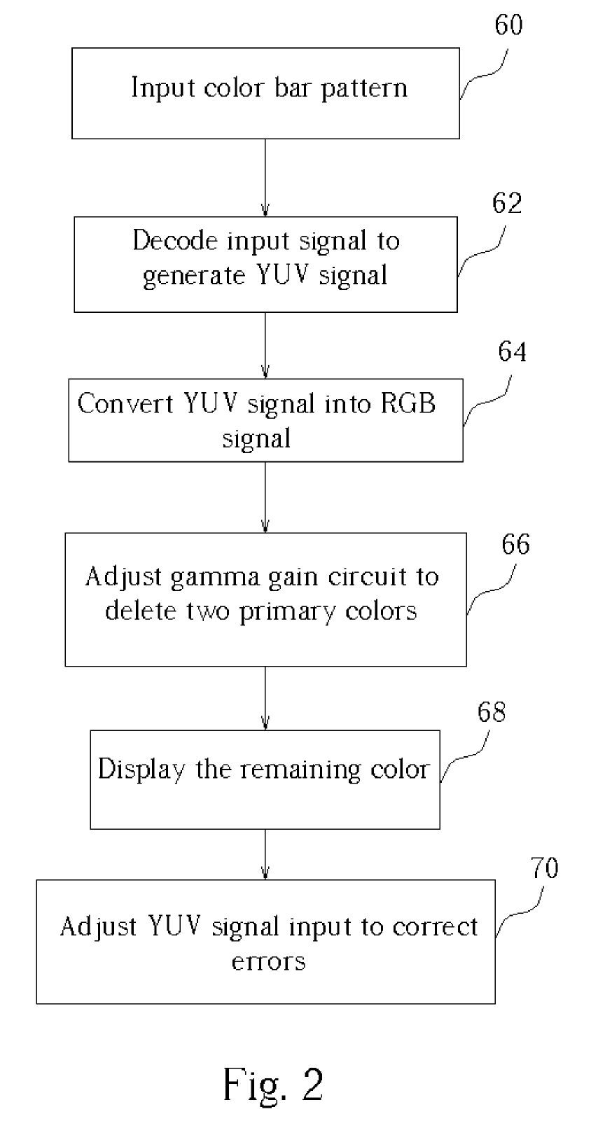

Please refer to FIG. 2. FIG. 2 is a flow chart illustrating a method for adjusting chromatic images of the display apparatus 10. The method includes following steps:

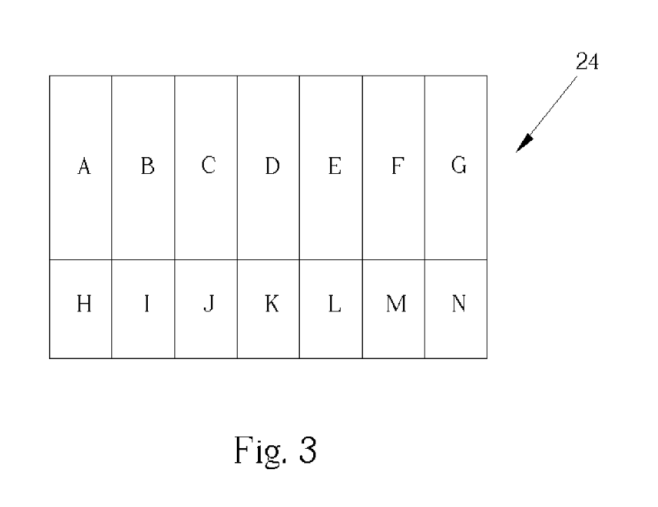

Step 60:Input the color bar pattern 24 to the input port 12. The color bar pattern 24 can be stored in a storing device, such as a recorder, a memory or a CD-ROM etc, or transmitted to the input port 12 by TV stations or cable TV providers. Please refer to FIG. 3. FIG. 3 is a diagram illustrating a color bar pattern 24. The color bar pattern 24 is composed of different color blocks, and letter A to N represents each color block.

Step 62:Decode the video signal of the color bar pattern 24 received at the input port 12 by the decoder 14 in order to generate a YUV signal.

Step 64:Convert the YUV signal of the decoded color bar pattern 24 into an RGB signal by the converter 16.

Step 66:Adjust the gamma gain circuit 18 by the adjusting device 22 to delete two of the primary colors so that the RGB signal becomes a single remaining primary color. The remaining primary color can be blue, red or green.

Step 68:Display the video signal with the remaining primary color.

Step 70:Adjust the YUV signal input by the adjusting device 22 according to the color bar pattern 24 with the remaining primary color, in order to correct the color bar pattern 24 displayed by the display panel 20.

A further introduction on adjusting chromatic signals by the color bar pattern 24 displayed by the display panel 20 as mentioned in Step 70 is disclosed hereinafter. Please refer to FIG. 3. In the case that the remaining primary color is blue, if the color of block A and block H as well as block G and block N in the color bar pattern 24 displayed on the display panel 20 match each other after adjustment by the adjusting device 22 the saturation adjustment is finished. In other words, if block A is the same color as block H and block G is the same color as block N then the saturation adjustment is finished. Because block A and block H are composed of the same blue color but have different red and green colors, when the color of block A and block H are adjusted to the same after the red and green colors are filtered, the adjustment of the blue color is finished. Block G and block N are adjusted in the same way. In the case of adjusting tint, adjust the color of block C and block J as well as block E and block L to match each other by the adjusting device 22, i.e. have block C show the same color as block J and have block E show the same color as block L and the tint adjustment is finished. This is essentially the same procedure to the saturation adjustment. Generally, when an adjustment on one primary color is finished, the adjustment on the other two primary colors is finished at the same time. Because video signal errors are often due to a coordinate shift on a chromaticity diagram instead of an error on a single primary color, only one primary color needs to be adjusted. Of course, adjusting three times by inputting signals with the three primary colors separately is also allowed.

By means of the steps mentioned above, it is possible to input one primary color by the gamma gain circuit 18 of the first display apparatus 10 in order to have the filter generate one primary color. The color bar pattern 24 displayed on the display panel 20 is then adjusted by the adjusting device 22 in order to modify errors due to signal decay or noise interference in the transmission of the input signal source.

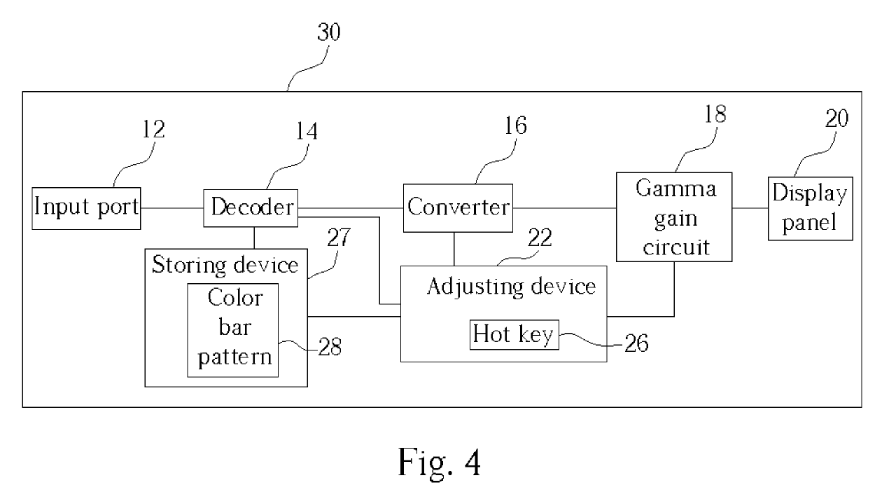

Please refer to FIG. 4. FIG. 4 is a diagram illustrating a second display apparatus 30 according to the second embodiment of the present invention. The difference between the first and second embodiments is that the color bar pattern 24 is input externally to the input port 12 in the first embodiment, while the second embodiment includes a color bar pattern 28 within the second display apparatus 30. The second display apparatus 30 also includes an input port 12 capable of receiving signals from a variety of signal sources such as TV stations, cable TV providers, or various types of storing devices such as recorders, memories or CD-ROMs. A decoder 14 is connected to the input port for decoding and generating a YUV signal and a converter 16 is connected to the decoder 14 for converting the YUV signal into an RGB signal. A gamma gain circuit 18 including program code is connected to the converter 16 for determining the gain of each color of the RGB signal converted by the converter 16, i.e. determining the output proportion of each color, and a display panel 20 for displaying the RGB signals adjusted by the gamma gain circuit 18 is connected to the gamma gain circuit 18. The display panel 20 can be an LCD panel, a CRT screen or a television screen.

The second display apparatus 30 further includes a storing device 27 for storing the color bar pattern 28, which is connected to an adjusting device 22. The adjusting device 22 is connected to the decoder 14, the converter 16, and the gamma gain circuit 18 for inputting the color bar pattern 28 stored in the storing device 27 to the decoder 14, and adjusting the input proportion of the YUV signal and the gain of each color of the RGB signal output by the gamma gain circuit 18. The adjusting device 22 further includes a hot key 26 for inputting the color bar pattern 28 to the decoder 14 when pressed, and causing the gamma gain circuit 18 to delete two of the primary colors to leave one single primary color output to the display panel 20.

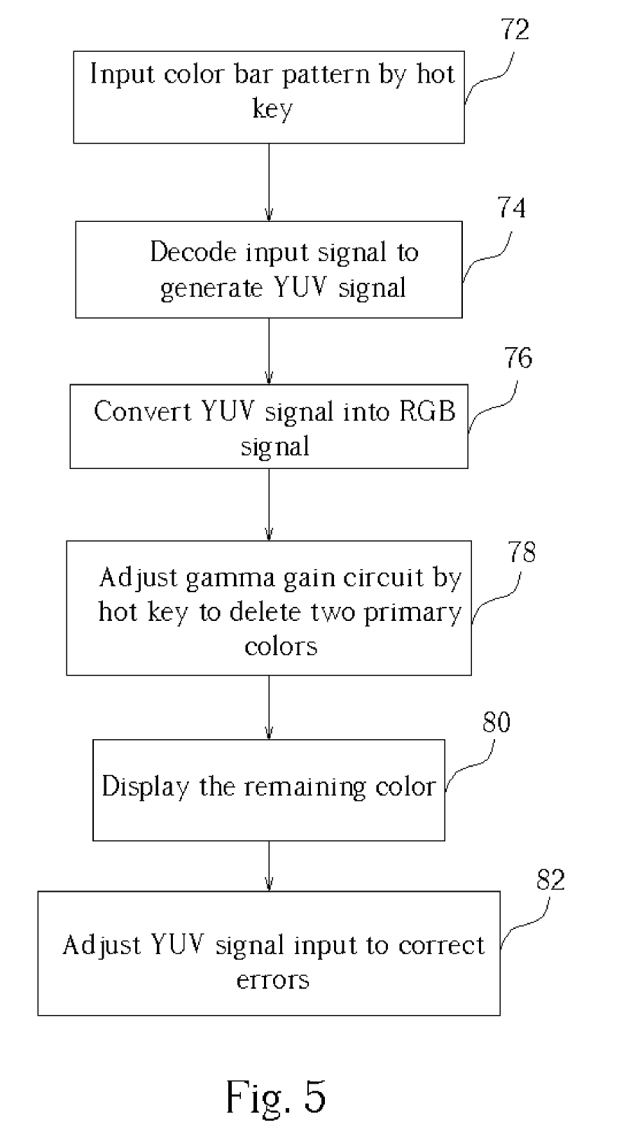

Please refer to FIG. 5. FIG. 5 is a flow chart illustrating a method for adjusting chromatic images of the second display apparatus 30. The method includes the following steps:

Step 72:Input the color bar pattern 28 stored in the storing device 27 to the decoder 14 by pressing the hot key 26 of the adjusting device 22.

Step 74:Decode the video signal of the color bar pattern 24 by the decoder 14 in order to generate a YUV signal.

Step 76:Convert the YUV signal of the decoded color bar pattern 24 into an RGB signal by the converter 16.

Step 78:Adjust the gamma gain circuit 18 by pressing the hot key 26 of the adjusting device 22 to delete two of the primary colors so that the RGB signal contains only one remaining primary color. The remaining primary color can be blue, red, or green.

Step 80:Display the video signal with the remaining primary color by the display panel 20.

Step 82:Adjust the YUV signal input by the adjusting device 22 according to the color bar pattern 28 with the remaining primary color, in order to correct the color bar pattern 28 displayed by a display panel 20.

The method shown in Step 82 using the adjusting device to adjust the YUV signal input in order to modify the color bar pattern 28 displayed on the display panel 20 is essentially the same to that in Step 70 of the first embodiment, so that a further description is hereby omitted.

By means of the steps mentioned above, it is possible to input one primary color by the color bar pattern 28 within the second display apparatus 30 and the gamma gain circuit 18 in order to have the filter generate one primary color, and then adjust the color bar pattern 28 displayed on the display panel 20 by the adjusting device 22 in order to correct errors due to signal decay or noise interference in transmission of the input signal source. Moreover, by means of the hot key 26 on the adjusting device 22, users are able to adjust the second display apparatus 30 in a more convenient and time efficient manner.

In contrast to the prior art, the present invention is capable of inputting one single primary color by a gamma gain circuit in order to have a filter generate one single primary color, so that other filtering devices are not need in image adjustment, and in such a way general users without professional filters are able to adjust images by themselves. Additionally, using a hot key to output one single primary color by the gamma gain circuit, users are able to adjust chromatic images in a more convenient and time efficient manner. Therefore the present invention is capable of adjusting chromatic images without additional filters or additional costs.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for adjusting chromatic images of a display apparatus comprising:
(a) decoding video signals of a color bar pattern and converting them into RGB signals;
(b) deleting two primary colors from the RGB signal;
(c) displaying the remaining primary color on the display apparatus; and
(d) adjusting the display apparatus according to the remaining primary color.

2. The method of claim 1 wherein the remaining primary color in Step (d) is blue.

3. The method of claim 1 wherein the remaining primary color in Step (d) is red.

4. The method of claim 1 wherein the remaining primary color in Step (d) is green

5. The method of claim 1 wherein the color bar pattern is stored in the display apparatus.

6. The method of claim 1 wherein Step (a) is to decode the video signals of the color bar pattern to generate YUV signals and convert them into the RGB signals, and Step (d) is to adjust the YUV signals according to the remaining primary color.

7. The method of claim 6 wherein the display apparatus further comprises an adjusting device for adjusting the YUV signals.

8. The method of claim 1 wherein the display apparatus is a monitor.

9. The method of claim 1 wherein the display apparatus is a projector.

10. The method of claim 1 wherein the display apparatus is a television.

11. A display apparatus implementing the method of claim 1.

12. A display apparatus comprising:
a gamma gain circuit for receiving RGB signals of a color bar pattern and controlling the deletion of two primary colors of the RGB signals;
a display panel connected to the gamma gain circuit for displaying a remaining primary color after deleting the two primary colors of the RGB signals; and
an adjusting device for adjusting video signals of the color bar pattern according to the remaining primary color in order to modify input video signal errors.

13. The display apparatus of claim 12 wherein the remaining primary color is blue.

14. The display apparatus of claim 12 wherein the remaining primary color is red.

15. The display apparatus of claim 12 wherein the remaining primary color is green.

16. The display apparatus of claim 12 wherein the color bar pattern is stored in the display apparatus.

17. The display apparatus of claim 12 being a monitor.

18. The display apparatus of claim 12 being a projector.

19. The display apparatus of claim 12 being a television.

20. The display apparatus of claim 12 wherein the gamma gain circuit comprises program code to control the deletion of the two primary colors of the RGB signal.

21. The display apparatus of claim 12 further comprising:
an input port for inputting video signals of the color bar pattern;
a decoder connected to the input port for decoding the video signals of the color bar pattern input to the input port in order to generate the YUV signals;
a converter connected to the decoder for converting the YUV signals into the RGB signals, and transmitting RGB signals to the gamma gain circuit.
